(19) United States
(12) Patent Application Publication
(10) Pub. No.: US 2025/0135434 A1
(43) Pub. Date: May 1, 2025

(54) Method for Preparing Super Absorbent Polymer

(71) Applicant: LG Chem, Ltd., Seoul (KR)

(72) Inventors: Yong Ho Yeo, Daejeon (KR); Jong Hun Kim, Daejeon (KR); YongJin Kim, Daejeon (KR)

(73) Assignee: LG Chem, Ltd., Seoul (KR)

(21) Appl. No.: 18/687,582

(22) PCT Filed: Jun. 1, 2023
(86) PCT No.: PCT/KR2023/007523

§ 371 Date: Feb. 28, 2024

(30) Foreign Application Priority Data
Oct. 21, 2022 (KR) 10-2022-0136874

(51) Int. Cl. B01J 20/26; B01J 20/28; B01J 20/30

(52) U.S. Cl. CPC B01J 20/261; B01J 20/267; B01J 20/28004; B01J 20/3021; B01J 2220/68

(57) ABSTRACT

A method for preparing a super absorbent polymer, includes: feeding a composition containing a water-soluble ethylenically unsaturated monomer having an acidic group of which at least a part is neutralized, an internal crosslinking agent, and a polymerization initiator to a polymerization reactor and subjecting the composition to a polymerization reaction to obtain a hydrous gel polymer; drying the hydrous gel polymer to obtain a dried substance; hydrating the dried substance to adsorb moisture to the dried substance; and pulverizing the hydrated dried substance to obtain a super absorbent polymer. The method reduces an amount of fine particles generated in the pulverization step, thereby increasing a yield of the super absorbent polymer.

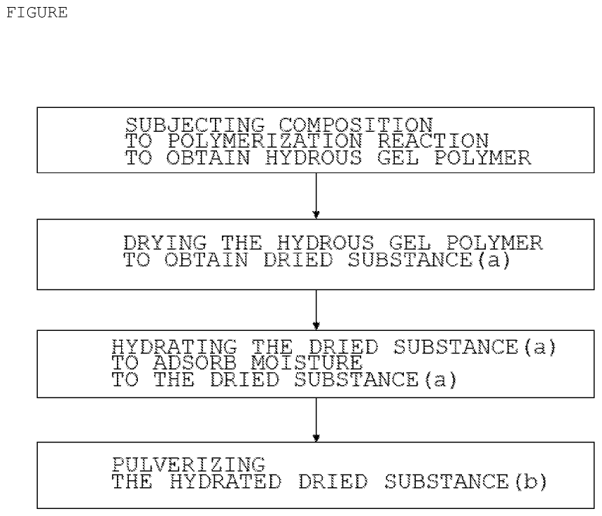

### CROSS-REFERENCE TO RELATED APPLICATIONS

The present application is a national phase entry under 35 U.S.C. § 371 of International Application No. PCT/KR2023/007523 filed Jun. 1, 2023, which claims priority to Korean Patent Application No. 10-2022-0136874 filed on Oct. 21, 2022, the entire contents of which are incorporated herein by reference.

### TECHNICAL FIELD

The present disclosure relates to a method for preparing a super absorbent polymer, and more particularly, to a method for preparing a super absorbent polymer in which the amount of fine particles generated is reduced through hydration.

### BACKGROUND ART

A super absorbent polymer (SAP) is a synthetic polymeric material capable of absorbing moisture in an amount of about 500 to 1,000 times its own weight. Various manufacturers have denominated it as different names, such as a super absorbency material (SAM) and an absorbent gel material (AGM). Although such super absorbent polymers started to be practically applied in sanitary products, now they have been widely used as water-retaining agents for gardening, water stop materials for civil engineering and construction, sheets for raising seedlings, fresh-keeping agents in the food distribution field, materials for poultice, and the like, and have been mainly used in hygiene products such as diapers and sanitary pads.

Meanwhile, there has been a problem in that the amount of fine particles generated is increased due to destruction of a surface of a dried substance in a pulverization step of a series of steps for preparing a super absorbent polymer. As such, when the fine particles are generated during the pulverization process, a yield of the super absorbent polymer to be finally commercialized may decrease by the amount of fine particles generated. Furthermore, the fine particles may be inhaled into the respiratory tract of a worker performing the pulverization step, resulting in health problems.

Therefore, there is a need for a method capable of reducing the amount of fine particles generated when pulverization is performed in the pulverization step.

### Technical Problem

In order to solve the above problems, an object of the present disclosure is to provide a method for preparing a super absorbent polymer capable of reducing the amount of fine particles generated in a pulverization step.

### Technical Solution

In one general aspect, a method for preparing a super absorbent polymer includes: feeding a composition containing a water-soluble ethylenically unsaturated monomer having an acidic group of which at least a part is neutralized, an internal crosslinking agent, and a polymerization initiator to a polymerization reactor and subjecting the composition to a polymerization reaction to obtain a hydrous gel polymer; drying the hydrous gel polymer to obtain a dried substance; hydrating the dried substance to adsorb moisture to the dried substance; and pulverizing the hydrated dried substance to obtain a super absorbent polymer.

### Advantageous Effects

According to the method for preparing a super absorbent polymer of the present disclosure, the dried substance after drying is hydrated, such that moisture may be adsorbed to the dried substance. A moisture content of the surface of the dried substance may be increased by the hydration, and through this, a phenomenon in which the surface of the dried substance is destroyed during pulverization may be suppressed. Therefore, the amount of fine particles generated as the surface of the dried substance is destroyed in the pulverization step may be reduced. In addition, the amount of fine particles generated is reduced, such that a yield of a super absorbent polymer to be finally commercialized may be increased.

### DESCRIPTION OF DRAWINGS

FIGURE is a flow chart illustrating a method for preparing a super absorbent polymer according to an exemplary embodiment of the present disclosure.

### DETAILED DESCRIPTION

The terms and words used in the description and claims of the present disclosure are not to be construed limitedly as having general or dictionary meanings but are to be construed as having meanings and concepts meeting the technical ideas of the present disclosure, based on a principle that the inventors are able to appropriately define the concepts of terms in order to describe their own inventions in the best mode.

Hereinafter, the present disclosure will be described in more detail with reference to FIGURE in order to assist in the understanding of the present disclosure.

A method for preparing a super absorbent polymer according to an exemplary embodiment of the present disclosure may include: feeding a composition containing a water-soluble ethylenically unsaturated monomer having an acidic group of which at least a part is neutralized, an internal crosslinking agent, and a polymerization initiator to a polymerization reactor and subjecting the composition to a polymerization reaction to obtain a hydrous gel polymer; drying the hydrous gel polymer to obtain a dried substance (a); hydrating the dried substance (a) to adsorb moisture to the dried substance (a); and pulverizing the hydrated dried substance (b) to obtain a super absorbent polymer.

First, in the method for preparing a super absorbent polymer according to an exemplary embodiment of the present disclosure, a step of feeding a composition containing a water-soluble ethylenically unsaturated monomer having an acidic group of which at least a part is neutralized, an internal crosslinking agent, and a polymerization initiator to a polymerization reactor and subjecting the composition to a polymerization reaction to obtain a hydrous gel polymer may be performed. As described above, the composition may contain a water-soluble ethylenically unsaturated monomer, an internal crosslinking agent, and a polymerization initiator, and in addition, may additionally contain additives such as a thickener, a plasticizer, a storage stabilizer, and an antioxidant, if necessary.

In this case, the water-soluble ethylenically unsaturated monomer may be (meth)acrylic acid or a salt thereof. When an alkali metal salt having acrylic acid of which at least a part is neutralized, which is acrylic acid or a sodium salt thereof, is used as the water-soluble ethylenically unsaturated monomer, a super absorbent polymer having improved absorbency may be obtained.

In addition, as the water-soluble ethylenically unsaturated monomer, an anionic monomer such as maleic anhydride, fumaric acid, crotonic acid, itaconic acid, 2-acryloylethane sulfonic acid, 2-methacryloylethane sulfonic acid, 2-(meth)acryloylpropane sulfonic acid, or 2-(meth)acrylamide-2-methyl propane sulfonic acid, and a salt thereof; a nonionic hydrophilic monomer such as (meth)acrylamide, N-substituted (meth)acrylate, 2-hydroxyethyl(meth)acrylate, 2-hydroxypropyl(meth)acrylate, methoxy polyethylene glycol(meth)acrylate, or polyethylene glycol (meth)acrylate; and an amino group-containing unsaturated monomer such as (N,N)-dimethylaminoethyl(meth)acrylate or (N,N)-dimethylaminopropyl(meth)acrylamide, and a quaternary compound thereof may be used. The salt of the anionic monomer may be a metal salt, a divalent metal salt, an ammonium salt, or an organic amine salt.

The water-soluble ethylenically unsaturated monomer may have an acidic group of which at least a part is neutralized. The water-soluble ethylenically unsaturated monomer having an acidic group of which at least a part is neutralized may be prepared by neutralizing the acidic group of the water-soluble ethylenically unsaturated monomer using a neutralizing agent. In this case, as the neutralizing agent, a basic material capable of neutralizing an acidic group, such as sodium hydroxide (or caustic soda), potassium hydroxide, or ammonium hydroxide may be used.

Meanwhile, the internal crosslinking agent may serve to polymerize the water-soluble ethylenically unsaturated monomers described above by crosslinking unsaturated bonds thereof.

The internal crosslinking agent may be a (meth)acrylate-based compound in which a crosslinking reaction proceeds by a free-radical polymerization (FRP) reaction. Specifically, the internal crosslinking agent may be one or more compounds selected from the group consisting of ethylene glycol di(meth)acrylate, polyethylene glycol (meth)acrylate, polyethylene glycol di(meth)acrylate, propylene glycol di(meth)acrylate, polypropylene glycol (meth)acrylate, butanediol di(meth)acrylate, butylene glycol di(meth)acrylate, diethylene glycol di(meth)acrylate, hexanediol di(meth)acrylate, triethylene glycol di(meth)acrylate, tripropylene glycol di(meth)acrylate, and tetraethylene glycol di(meth)acrylate. More specifically, the internal crosslinking agent may be one or more of ethylene glycol di(meth)acrylate, polyethylene glycol (meth)acrylate, and polyethylene glycol di(meth)acrylate.

Meanwhile, in the composition, as the polymerization initiator, a thermal polymerization initiator or a photo-polymerization initiator by UV irradiation may be used according to a polymerization method. However, even when the polymerization is performed by the photo-polymerization method, a certain amount of heat may be generated by irradiation with ultraviolet rays, and a certain amount of heat is generated according to the progression of the polymerization reaction, which is an exothermic reaction, and therefore, a thermal polymerization initiator may be additionally included.

As the photo-polymerization initiator, a compound capable of forming a radical by light such as ultraviolet rays may be used. As the photo-polymerization initiator, one or more selected from the group consisting of benzoin ether, dialkyl acetophenone, hydroxyl alkylketone, phenyl glyoxylate, benzyl dimethyl ketal, acyl phosphine, and α-aminoketone may be used. Meanwhile, specific examples of the acyl phosphine include diphenyl(2,4,6-trimethylbenzoyl)phosphine oxide, bis(2,4,6-trimethylbenzoyl)phenylphosphine oxide, and ethyl(2,4,6-trimethylbenzoyl)phenylphosphinate.

In addition, as the thermal polymerization initiator, one or more selected from the group consisting of a persulfate-based initiator, an azo-based initiator, hydrogen peroxide, and ascorbic acid may be used. Specifically, examples of the persulfate-based initiator include sodium persulfate (Na₂S₂O₈), potassium persulfate (K₂S₂O₈), and ammonium persulfate ((NH₄)₂S₂O₈).

Specifically, the polymerization method is largely divided into thermal polymerization and photo-polymerization according to a polymerization energy source. The thermal polymerization may be performed in a polymerization reactor equipped with a stirring shaft, such as a kneader, and the photo-polymerization may be performed in a polymerization reactor equipped with a movable conveyor belt.

The hydrous gel polymer of the present disclosure may be prepared by the polymerization reaction that proceeds by feeding a composition containing a water-soluble ethylenically unsaturated monomer, an internal crosslinking agent, and a polymerization initiator to a polymerization reactor, and in this case, the amount of the internal crosslinking agent in the composition may be 0.01 to 5 parts by weight with respect to 100 parts by weight of the water-soluble ethylenically unsaturated monomer. For example, the amount of the internal crosslinking agent may be 0.01 parts by weight or more, 0.05 parts by weight or more, 0.1 parts by weight, or 0.2 parts by weight or more, and 5 parts by weight or less, 3 parts by weight or less, 2 parts by weight or less, 1 part by weight or less, or 0.5 parts by weight or less, with respect to 100 parts by weight of the water-soluble ethylenically unsaturated monomer. When the content of the internal crosslinking agent is excessively low, crosslinking does not occur sufficiently, which makes it difficult to realize an appropriate level or higher of strength, and when the content of the internal crosslinking agent is excessively high, an internal crosslinking density increases, which makes it difficult to realize a desired water retention capacity.

The composition of the present disclosure may be prepared in the form of a solution dissolved in a solvent. In this case, as a usable solvent, a solvent capable of dissolving the raw materials described above may be used. For example, as the solvent, water, ethanol, ethylene glycol, diethylene glycol, triethylene glycol, 1,4-butanediol, propylene glycol, ethylene glycol monobutyl ether, propylene glycol monomethyl ether, propylene glycol monomethyl ether acetate, methyl ethyl ketone, acetone, methyl amyl ketone, cyclohexanone, cyclopentanone, diethylene glycol monomethyl ether, diethylene glycol ethylether, toluene, xylene, butyrolactone, carbitol, methyl cellosolve acetate, N,N-dimethylacetamide, or a mixture thereof may be used.

Next, a step of drying, pulverizing, and classifying the hydrous gel polymer formed through the polymerization reaction of the composition may be followed. In this case, in order to increase the efficiency in drying the hydrous gel polymer, a coarse pulverization step may be additionally performed. As a pulverizer used in the coarse pulverization step, specifically, one selected from the group consisting of a vertical pulverizer, a turbo cutter, a turbo grinder, a rotary cutter mill, a cutter mill, a disc mill, a shred crusher, a crusher, a chopper, and a disc cutter may be used.

Meanwhile, the method for preparing a super absorbent polymer of the present disclosure will be described with reference to the flow chart of FIGURE. The method for preparing a super absorbent polymer of the present disclosure may include drying the hydrous gel polymer that is coarse pulverized or is not subjected to the coarse pulverization step as described above to obtain a dried substance (a). The drying step may be performed by a drying method, specifically, by hot air supply, irradiation with infrared rays, irradiation with microwaves, or irradiation with ultraviolet rays, and the dried substance (a) may be obtained by performing the drying step according to the drying method described above.

In this case, a moisture content of the dried substance (a) may be from 2 to 9 wt %. More specifically, the moisture content of the dried substance (a) may be from 3 to 7 wt % or from 4 to 6 wt %. In this case, the moisture content of the dried substance (a) may refer to a moisture content of the dried substance (a) that is subjected to the drying step but is not subjected to subsequent hydration. When the moisture content of the dried substance is less than 2 wt %, a content of fine particles in the dried substance may be excessively increased in a state where the dried substance is overdried. When the moisture content of the dried substance exceeds 9 wt %, the dried substance may be regarded as an undried substance, and when the dried substance is hydrated and then introduced into a subsequent pulverization step, pulverization may not be possible.

The method for preparing a super absorbent polymer according to an exemplary embodiment of the present disclosure may include hydrating the dried substance (a) to adsorb moisture to the dried substance (a). Specifically, a certain amount of moisture is adsorbed to a surface of the dried substance (a) by the hydration, and through this, a hydrated dried substance (b) may be obtained.

The hydration may be performed under a temperature a condition of from 15° C. to 70° C., and specifically, temperature condition of from 20° C. to 40° C. Through this, it is possible to maintain an appropriate amount of moisture on the surface of the dried substance (a), such that smooth hydration may be possible. Specifically, the hydration temperature may be a droplet temperature when the hydration is performed by spray hydration.

The hydration is performed under the conditions described above, and as a means capable of creating this atmosphere, for example, the hydration may be performed by directly spraying moisture. Moisture may be adsorbed to the surface of the dried substance (a) by such hydration. Moisture adsorbed to the surface of the hydrated dried substance (b) as described above may diffuse and be absorbed into the inside over time.

The amount of moisture adsorbed to the dried substance (a) by the hydration may be 1 wt % or more, 2 wt % or more, or 3 wt % or more, and 10 wt % or less, 7 wt % or less, or 5 wt % or less, with respect to 100 wt % of the dried substance (a). The amount of moisture adsorbed may refer to the amount of moisture adsorbed to the dried substance (a) by the hydration. When moisture is adsorbed to the dried substance (a) within the above range, a moisture content of the hydrated dried substance (b) may reach a desired level in the present disclosure. In this case, the amount of moisture adsorbed may be measured according to the International Organization for Standardization (ISO) 171904-4:2001 method.

Meanwhile, the moisture content of the hydrated dried substance (b) may be 5 wt % or more, 6 wt % or more, or 9 wt % or more, and 15 wt % or less, 13 wt % or less, or 11 wt % or less. In this case, the moisture content of the hydrated dried substance (b) may refer to a moisture content of the hydrated dried substance (b) that is subjected to the hydration but is not subjected to a subsequent pulverization step. When the moisture content of the hydrated dried substance (b) is within the above range, the amount of fine particles generated in a pulverization step described below may be reduced to, for example, a level of less than 20%. Therefore, the amount of moisture adsorbed to the dried substance (a) may be adjusted during hydration so that the moisture content of the hydrated dried substance (b) is controlled within the above range.

When the moisture content of the hydrated dried substance (b) is less than 5 wt %, it may be difficult to reduce the generation of fine particles during pulverization, which is targeted in the present disclosure. When the moisture content of the hydrated dried substance (b) exceeds 15 wt %, the moisture content of the hydrated dried substance (b) is excessively high, and thus, pulverization performed in the pulverization step may be impossible. In this case, the moisture content may be measured by a moisture meter (AND MX_50).

According to the preparation method according to an exemplary embodiment of the present disclosure, the preparation method may include pulverizing the hydrated dried substance (b) to obtain a super absorbent polymer. The pulverization step may be performed one time, but may be performed, for example, one or more times. When the dried substance that is not hydrated is pulverized as in the related art, fine particles are excessively generated because the surface of the dried substance is destroyed. In general, the fine particle has a particle size (D50) of less than 150 μm, and may be inappropriate for commercialization as a super absorbent polymer. In this case, the particle size (D50) may refer to a particle size at a point of 50% in a cumulative distribution of the number of particles according to the particle size. Therefore, as the amount of fine particles generated in the pulverization step increases, the yield of the super absorbent polymer may decrease. However, in the present disclosure, hydration is performed before the pulverization step, such that moisture may be adsorbed to the surface of the dried substance (a) and destruction of the surface of the hydrated dried substance (b) may be suppressed due to the moisture. Through this, the amount of fine particles generated during pulverization may be reduced, and the yield of the super absorbent polymer may be increased.

Meanwhile, as a pulverizer used in the pulverization step, specifically, a ball mill, a pin mill, a hammer mill, a screw mill, a roll mill, a disc mill, or a jog mill may be used.

According to an exemplary embodiment of the present disclosure, the pulverizing of the hydrated dried substance (b) to obtain the super absorbent polymer may be performed immediately after the hydration of the dried substance (a) to within 24 hours after the hydration. Immediately after the hydration may mean immediately after the hydration is completed or a minimum time required for the pulverization step after the hydration. As such, the content of moisture on the surface H the hydrated dried substance (b) immediately after the hydration may be higher, and through this, when the pulverization step is performed immediately after the hydration, the surface of the hydrated dried substance (b) is prevented from being destroyed, and thus, a desired result may be obtained. Therefore, when the amount of moisture adsorbed during the hydration is relatively small, even though the amount of moisture adsorbed is, for example, 1 wt % to 3 wt %, in a case where the pulverization step is performed immediately after the hydration, the moisture does not diffuse from the surface of the hydrated dried substance (b) to the inside, and therefore, the amount of fine particles generated during pulverization may be reduced.

Meanwhile, moisture present on the surface of the hydrated dried substance (b) may diffuse into the inside as time elapses after the hydration. However, when the amount of moisture adsorbed to the dried substance (a) during the hydration is, for example, 4 wt % to 10 wt %, which is relatively high, even when the hydrated dried substance (b) is stabilized for a certain period of time, the amount of moisture remaining on the surface of the hydrated dried substance (b) may be maintained high. Therefore, when the pulverization step is performed after the stabilization process, the destruction of the surface of the hydrated dried substance (b) is prevented, such that the amount of fine particles generated may be reduced. In this case, the stabilization may mean, for example, aging the hydrated dried substance (b) for a certain period of time in a humid atmosphere in an airtight container.

Meanwhile, in order to manage the physical properties of the super absorbent polymer to be finally commercialized after the pulverization step, the hydrated dried substance (b) may be subjected to an additional classification process according to an appropriate particle size. Furthermore, the classification may be performed after each pulverization.

In this case, the appropriate particle size (D50) may be a particle size of 150 μm to 850 μm, and particles having such a particle size may be classified as normal particles. On the other hand, particles having a particle size of less than 150 μm as described above may be classified as fine particles. Such a particle size may be measured according to European Disposables and Nonwovens Association (EDANA) standard EDANA WSP 220.3 method.

Through a series of pulverization steps, normal particles, that is, a super absorbent polymer, may be prepared.

Thereafter, the preparation method may further include crosslinking a surface of the prepared super absorbent polymer in the presence of a surface crosslinking agent to prepare a super absorbent polymer having a surface on which a crosslinked layer is at least partially formed. In this case, the surface crosslinked layer may be produced from a surface crosslinking agent, the surface crosslinking agent may include a polyhydric epoxy compound, and the polyhydric epoxy compound may be a glycidyl ether compound of a polyhydric alcohol.

Specifically, the surface crosslinking agent may include one or more polyhydric epoxy compounds selected from the group consisting of ethyleneglycol diglycidyl ether, diethyleneglycol diglycidyl ether, triethyleneglycol diglycidyl ether, tetraethyleneglycol diglycidyl ether, glycerin polyglycidyl ether, and sorbitol polyglycidyl ether.

The surface crosslinking agent may be mixed with the super absorbent polymer in a solution state, specifically, in a surface crosslinking solution state dissolved in a solvent. The surface crosslinking solution may include water and methanol in addition to the surface crosslinking agent. In general, the surface crosslinking solution is applied to the surface of the super absorbent polymer. Therefore, a surface crosslinking reaction occurs on the surface of the super absorbent polymer, which improves crosslinkability on the surface of the particle without substantially affecting the inside of the particle. Accordingly, the surface crosslinked super absorbent polymer has a higher degree of crosslinking near the surface than the inside. The surface crosslinking reaction and drying may be simultaneously performed by heating the super absorbent polymer to which the surface crosslinking agent is added.

Hereinafter, the present disclosure will be described in more detail by Examples. However, the following Examples are provided for illustrating the present disclosure. It is apparent to those skilled in the art that various modifications and alterations may be made without departing from the scope and spirit of the present disclosure, and the scope of the present disclosure is not limited thereto.

### EXAMPLES

### Example 1

In a 3 L glass vessel equipped with a stirrer and a thermometer, 100 g of acrylic acid, 0.16 g of polyethylene glycol diacrylate (PEGDA) as an internal crosslinking agent, 0.008 g of diphenyl (2,4,6-trimethylbenzoyl) phosphine oxide as a photo-polymerization initiator, a polymerization initiator, 0.12 g of sodium persulfate as a thermal polymerization initiator, and 123.5 g of a caustic soda (NaOH) solution as a neutralizing agent were mixed at room temperature so that a solid content was 45.0 wt %, thereby preparing a composition.

Thereafter, the composition was fed at a speed of 500 to 2,000 mL/min onto a conveyor belt on which a belt having a width of 10 cm and a length of 2 m moved at a speed of 10 cm/min. At this time, a polymerization reaction was allowed to proceed for 60 seconds by irradiation with ultraviolet rays with an intensity of 10 mW/cm² while feeding the monomer composition, thereby obtaining a hydrous gel polymer.

Next, the hydrous gel polymer was coarse pulverized using a chopper. Thereafter, the pulverized hydrous gel polymer was dried in hot air at 185° C. for 30 minutes using an air-flow oven. Through this, 100 g of a dried substance having a moisture content of 5 wt % was obtained.

The dried substance was evenly spread on a SUS tray having a size of 320 mm□×200 mm□×50 mm and then hydrated by spraying 3.2 g of moisture. The amount of moisture adsorbed to the dried substance was 3 wt % with respect to 100 wt % of the dried substance, and the amount of moisture adsorbed was measured according to the International Organization for Standardization (ISO) 17190-4:2001 method. The moisture content of the dried substance hydrated by spray hydration was 8 wt %. Subsequently, the hydrated dried substance was put into an airtight container and then shaken for mixing. Thereafter, the hydrated dried substance was stabilized in the airtight container for 24 hours.

As such, after the hydrated dried substance was stabilized in the airtight container, the hydrated dried substance was pulverized with a roll mill to obtain a pulverized product. The pulverized product was put into a mesh set obtained by combining ASTM standard meshes #6, #10, #20, #25, #30, #40, #50, #70, #80, and #100, and the mesh set was mounted on a sieve shaker. The sieve shaker was operated at an amplitude of 1.5 mm for 10 minutes to classify the pulverized product. Therefore, a super absorbent polymer having a particle size of 150 μm to 850 μm was obtained.

### Example 2

A super absorbent polymer was prepared in the same manner as that of Example 1, except that the dried substance was hydrated by spraying 5.8 g of moisture (the amount of moisture adsorbed was 5 wt % with respect to 100 wt % of the dried substance), and the moisture content of the hydrated dried substance was 10 wt %.

### Example 3

A super absorbent polymer was prepared in the same manner as that of Example 1, except that the dried substance was hydrated by spraying 11 g of moisture (the amount of moisture adsorbed was 10 wt % with respect to 100 wt % of the dried substance), and the moisture content of the hydrated dried substance was 15 wt %.

### Example 4

A super absorbent polymer was prepared in the same manner as that of Example 1, except that the dried substance was hydrated by spraying 1.1 g of moisture (the amount of moisture adsorbed was 1 wt % with respect to 100 wt % of the dried substance), the moisture content of the hydrated dried substance was 6 wt %, and pulverization was performed immediately after the hydration without a stabilization process of the hydrated dried substance.

### Example 5

A super absorbent polymer was prepared in the same manner as that of Example 1, except that the dried substance was hydrated by spraying 1.1 g of moisture (the amount of moisture adsorbed was 1 wt % with respect to 100 wt % of the dried substance), the moisture content of the hydrated dried substance was 6 wt %, and a stabilization process of the hydrated dried substance was performed for 1 hour.

### Example 6

A super absorbent polymer was prepared in the same manner as that of Example 1, except that the dried substance having a moisture content of 2 wt % was hydrated by spraying 3.2 g of moisture (the amount of moisture adsorbed was 3 wt % with respect to 100 wt % of the dried substance), the moisture content of the hydrated dried substance was 5 wt %, and pulverization was performed immediately after the hydration without a stabilization process of the hydrated dried substance.

### Example 7

A super absorbent polymer was prepared in the same manner as that of Example 1, except that the dried substance was hydrated by spraying 18 g of moisture (the amount of moisture adsorbed was 15 wt % with respect to 100 wt % of the dried substance), and the moisture content of the hydrated dried substance was 20 wt %.

### Example 8

A super absorbent polymer was prepared in the same manner as that of Example 1, except that the dried substance was hydrated by spraying 26 g of moisture (the amount of moisture adsorbed was 20 wt % with respect to 100 wt % of the dried substance), and the moisture content of the hydrated dried substance was 25 wt %.

### COMPARATIVE EXAMPLES

### Comparative Example 1

A super absorbent polymer was prepared in the same manner as that of Example 1, except that the dried substance was directly pulverized without hydration.

### Comparative Example 2

A super absorbent polymer was prepared in the same manner as that of Example 1, except that the dried substance having a moisture content of 2 wt % was directly pulverized without hydration.

### Comparative Example 3

A super absorbent polymer was prepared in the same manner as that of Example 1, except that the dried substance having a moisture content of 10 wt % was directly pulverized without hydration.

### Experimental Examples

The super absorbent polymers prepared in Examples and Comparative Examples were measured by the following methods. The measurement results are shown in Table 1.

### 1) Moisture Content

The moisture content may refer to a moisture content of the hydrated dried substance after hydration and before pulverization when hydration is performed (Examples), and may refer to a moisture content of the dried substance after drying and before pulverization when hydration is not performed (Comparative Examples). Specifically, the moisture content was measured through a change in weight caused by evaporating moisture by heating the hydrated dried substance or the dried substance with a halogen lamp (400 W) in a moisture meter (AND MX_50). Specifically, the moisture content was measured according to the following procedure.
\textcircled{1} The measurement conditions of the moisture meter (heating temperature: 180° C., heating time: 40 minutes) were set.
\textcircled{2} The weight was set to zero (0) in a state where no sample was present on a sample pan.
\textcircled{3} 5 g (error: 0.02%) of a sample of the hydrated dried substance or the dried substance was sampled and evenly loaded on the sample pan.
\textcircled{4} After the measurement was completed, a moisture content was confirmed.

### 2) Amount of Fine Particles Generated

The amount of fine particles generated may refer to the amount of particles including fine particles having a particle size of less than 150 μm in a pulverized product pulverized through a pulverization step. Specifically, the amount of fine particle generated was measured by the following method.

First, 100 g of a sample of the pulverized product pulverized in Examples and Comparative Example was sampled, and the sample was put into a mesh set obtained by combining ASTM standard meshes #6, #10, #20, #25, #30, #40, #50, #70, and #100. The mesh set was mounted on a sieve shaker, and the sieve shaker was operated at an amplitude of 1.5 mm for 10 minutes, thereby classifying the pulverized product by particle size according to each mesh. Subsequently, a mesh ratio corresponding to each mesh was calculated according to the following Equation 1.

$$Mesh ratio ( wt \% ) = \frac{Weight of pulverized classified by mesh}{Total weight of pulverized product} \qquad [ Equation 1 ]$$

Next, the amount of fine particles generated was measured by adding the mesh ratio of the pulverized product corresponding to less than #100 (particle size of less than 150 μm).

### 3) Particle Size

The particle size was measured by measuring a particle size of the pulverized product, and was calculated according to the following Equation 2 by classifying the pulverized product (100 g) with a mesh set in the same manner as the method of measuring “Amount of Fine Particles Generated” described above.

$$[ Equation 2 ]$$

$$Particle size ( µm ) = \frac{\begin{matrix}Average particle size of respective meshes ( \#40 to 100 ) \times \\ Ratios of respective meshes ( \#40 to 100 )\end{matrix}}{Total ratio of respective meshes ( \#40 to 100 )}$$

At this time, the respective meshes (#40 to 100) are the respective meshes from #40 to #100 included in the mesh set, and the mesh ratio is the mesh ratio according to Equation 1 described above. That is, the particle size is a value obtained by calculating the arithmetic average of the average particle size based on the mesh ratios of meshes #40 to #100.

TABLE 1

| | | | | | Amount of |
|---|---|---|---|---|---|
| | Amount of | Stabili- | | | fine |
| | moisture | zation | Moisture | Particle | particles |
| | adsorbed¹⁾ | time²⁾ | content | size | generated |
| | (wt %) | (h) | (wt %) | (μm) | (wt %) |
| Example 1 | 3 | 24 | 8 | 383.9 | 17.9 |
| Example 2 | 5 | 24 | 10 | 387.6 | 16.5 |
| Example 3 | 10 | 24 | 15 | 393.4 | 14.1 |
| Example 4 | 1 | 0 | 6 | 391.9 | 15.8 |
| Example 5 | 1 | 1 | 6 | 386.0 | 17.3 |
| Example 6 | 3 | 0 | 5 | 387.5 | 18.6 |
| Example 7 | 15 | 24 | 20 | cannot be | — |
| | | | | pulverized | |
| Example 8 | 20 | 24 | 25 | cannot be | — |
| | | | | pulverized | |
| Comparative | — | — | 5 | 394.4 | 20.5 |
| Example 1 | | | | | |
| Comparative | — | — | 2 | 387.9 | 25.4 |
| Example 2 | | | | | |
| Comparative | — | — | 10 | cannot be | — |
| Example 3 | | | | pulverized | |

¹⁾The amount of moisture adsorbed represents the amount of moisture adsorbed to the dried substance during hydration.
²⁾The stabilization time refers to a certain time when the hydrated dried substance is put into the airtight container and then aged for the certain time.

Referring to Table 1, it could be confirmed that in the cases of Examples in which hydration was performed by adsorbing moisture to the dried substance and then the pulverization step was performed, moisture was adsorbed to the surface of the dried substance by the hydration, and thus, the amount of fine particles generated due to destruction of the surface caused in the pulverization step was reduced. In addition, it could be confirmed that, compared to Comparative Example 1 in which the hydration step was not performed on the dried substance having a moisture content of 5 wt %, in Examples 1 to 5 in which the hydration was performed on the dried substance having the same moisture content, the amount of fine particles generated was small.

However, in the cases of Examples 7 and 8 in which a large amount of moisture was adsorbed during the hydration, and the moisture content of the hydrated dried substance to be obtained in the present disclosure was excessively increased, it could be confirmed that pulverization was impossible in the pulverization step.

Meanwhile, in Comparative Example 1 in which the super absorbent polymer was prepared by pulverizing the dried substance having a moisture content of 5 wt %, which was not subjected to a hydration step, it could be confirmed that the amount of fine particles generated was significantly increased compared to Examples 1 to 5. In Examples 1 and 5, the dried substance having the same moisture content as in Comparative Example 1 was hydrated and pulverized, but in Comparative Example 1, the dried substance was not hydrated and was subjected to the pulverization step, and thus, it could be confirmed that the surface of the dried substance was destroyed, resulting in an increase in the amount of fine particles generated.

In addition, in Comparative Example 2 in which the super absorbent polymer was prepared by pulverizing the dried substance having a moisture content of 2 wt %, which was not subjected to a hydration step, it could be confirmed that the amount of fine particles generated was significantly increased compared to Example 6 in which the dried substance having the same moisture content was hydrated. As described above, it could be confirmed that the amount of fine particles generated was improved depending on whether or not the hydration step was performed on the dried substance having the same moisture content.

Meanwhile, in Comparative Example 3 in which the hydration step was not performed, and the dried substance having a moisture content of 10 wt % was pulverized, it could be confirmed that pulverization was impossible. As such, when the moisture content of the dried substance was high, the hydrous gel polymer could be in an undried state in the drying step, and when the hydrous gel polymer in the undried state was introduced into the pulverization step, the hydrous gel polymer was not pulverized as in Comparative Example 3.

1. A method for preparing a super absorbent polymer, comprising:
feeding a composition containing a water-soluble ethylenically unsaturated monomer having an acidic group of which at least a part is neutralized, an internal crosslinking agent, and a polymerization initiator to a polymerization reactor and subjecting the composition to a polymerization reaction to obtain a hydrous gel polymer;
drying the hydrous gel polymer to obtain a dried substance;
hydrating the dried substance to adsorb moisture to the dried substance to form a hydrated dried substance; and
pulverizing the hydrated dried substance to obtain the super absorbent polymer.

2. The method of claim 1, further comprising, before the drying of the hydrous gel polymer, coarse pulverizing the hydrous gel polymer.

3. The method of claim 1, wherein the pulverizing of the hydrated dried substance to obtain the super absorbent polymer is performed immediately after the hydrating to within 24 hours after the hydrating.

4. The method of claim 1, wherein an amount of moisture adsorbed to the dried substance by the hydrating is from 1 wt % to 10 wt % with respect to 100 wt % of the dried substance.

5. The method of claim 1, wherein the hydrating is performed by spraying moisture onto the dried substance.

6. The method of claim 1, wherein the hydrating is performed under a temperature condition of from 15° C. to 70° C.

7. The method of claim 1, wherein a moisture content of the hydrated dried substance is from 5 wt % to 15 wt %.

8. The method of claim 1, further comprising, after the pulverizing of the hydrated dried substance to obtain the super absorbent polymer, crosslinking a surface of the super absorbent polymer in the presence of a surface crosslinking agent to form a surface crosslinked layer on at least a portion of the surface of the super absorbent polymer.

9. The method of claim 1, wherein the internal crosslinking agent is one or more compounds selected from the group consisting of ethylene glycol di(meth)acrylate, polyethylene glycol (meth)acrylate, and polyethylene glycol di(meth)acrylate.

10. The method of claim 1, wherein the water-soluble ethylenically unsaturated monomer is (meth)acrylic acid or a salt thereof.

11. The method of claim 1, wherein a moisture content of the dried substance may be from 2 to 9 wt %.

12. The method of claim 8, wherein the surface crosslinking agent includes one or more polyhydric epoxy compounds selected from the group consisting of ethyleneglycol diglycidyl ether, diethyleneglycol diglycidyl ether, triethyleneglycol diglycidyl ether, tetraethyleneglycol diglycidyl ether, glycerin polyglycidyl ether, and sorbitol polyglycidyl ether.
